(19) United States
(12) Patent Application Publication
(10) Pub. No.: US 2026/0119245 A1
(43) Pub. Date: Apr. 30, 2026

(54) ARTIFICIAL INTELLIGENCE-BASED SYSTEM MANAGEMENT

(71) Applicant: Dell Products L.P., Round Rock, TX (US)

(72) Inventor: DHARMESH M. PATEL, Round Rock, TX (US)

(21) Appl. No.: 18/932,863

(22) Filed: Oct. 31, 2024

(51) Int. Cl. G06F 9/50

(52) U.S. Cl. CPC G06F 9/5027

(57) ABSTRACT

Methods, systems, and devices are provided for managing operation of a system. To do so, a non-actionable description of a goal may be obtained for use of an artificial intelligence (AI) model in a workflow performed by the system. Key performance indicators (KPI) may also be obtained for this use. Based on the non-actionable description and/or the KPI, metrics may be obtained. An AI architecture may be selected for the AI model based on the metrics and/or the KPI, and, based at least on the KPI, a hardware system may be selected for the AI architecture. Based on what is selected, deployment of the system may then be initiated to facilitate the use of the AI model in the workflow.

### FIELD

Embodiments disclosed herein relate generally to management of data processing systems. More particularly, embodiments disclosed herein relate to systems and methods for management of artificial intelligence-based systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating systems in accordance with an embodiment.

FIGS. 2A-2E show data flow diagrams illustrating data and processes for facilitating an architectural regulation framework in accordance with an embodiment.

FIG. 3 shows a flow diagram illustrating a method for managing operation of a system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing data processing systems that may provide, at least in part, computer implemented services. The computer implemented services may be provided to any type and/or number of other devices and/or users of the data processing systems. Furthermore, the provided computer implemented services may be of any quantity and/or type of such services.

To provide the computer implemented services, data processing systems may include hardware components and/or software components. For example, operation of these components may facilitate various functionalities of a data processing system, thereby causing the data processing system to provide the computer implemented services. Additionally, such operation of the components may depend on how such components interact with one another and/or data each component may be adapted to use, for example, as specified by a system architecture in which these components may be a part.

For example, by changing how the components interact with one another, thereby changing the system architecture, the operation may be updated, and thus, may facilitate the various functionalities in a different (e.g., updated) manner and/or facilitate new functionalities all together than those prior to the update. Consequently, if the components are not configured to be in a correct architecture, then the services may not be provided as expected or desired by a consumer of such services.

To increase a likelihood of providing computer implemented services as expected and/or desired by a consumer of such services, a distributed system may leverage an architectural regulation framework.

This architectural regulation framework may include (i) obtaining an artificial intelligence (AI) model adapted for use in a workflow performed by a managed system, and (ii) deploying this AI model as part of that workflow.

In an embodiment, a method for managing operation of a system is provided.

The method may include obtaining, by a management system, a non-actionable description of a goal for use of an artificial intelligence model in a workflow performed by a managed system; obtaining, by the management system, key performance indicators for the use of the artificial intelligence model in the workflow; obtaining, by the management system, metrics based on the non-actionable description and/or the key performance indicators; selecting, by the management system, an artificial intelligence architecture for the artificial intelligence model based on the metrics and/or the key performance indicators; selecting, by the management system, a hardware system for the artificial intelligence architecture based at least on the key performance indicators; and initiating, by the management system, deployment of the managed system based on the artificial intelligence architecture and the hardware system to facilitate the use of desired computer implemented services using the artificial intelligence model in the workflow.

The obtaining of the non-actionable description may include distributing a first prompt regarding an existing approach used in the workflow and a desired change in the existing approach that is likely to improve a business goal for the workflow; and obtaining a first response to the first prompt.

The obtaining of the key performance indicators may include distributing a second prompt regarding quantifiable measurements for success of the desired change in the existing approach; and obtaining a second response to the second prompt.

The obtaining of the metrics may include discriminating a portion of a knowledge base of information regarding managed systems managed by the management system; and inferring, using the portion of the knowledge base, the metrics.

The metrics may include quantifications regarding operation of artificial intelligence models, and the key performance indicators may include quantifications regarding success in using the artificial intelligence architecture in future performances of the workflow.

The artificial intelligence architecture may include an artificial intelligence model.

The artificial intelligence architecture may further include configurations for use of the artificial intelligence architecture.

The hardware system may include hardware components.

The hardware system may further include configurations for the hardware components.

The metrics may include accuracy, precision, recall, F1 score, mean absolute error (MAE), mean squared error (MSE), training and inference time, resource utilization, latency, throughput, robustness, and scalability.

In an embodiment, a non-transitory media is provided. The non-transitory media may include instructions that when executed by a processor cause, at least in part, the computer-implemented method to be performed.

In an embodiment, a data processing system is provided. The data processing system may include the non-transitory media and a processor and may, at least in part, perform the method when the computer instructions are executed by the processor.

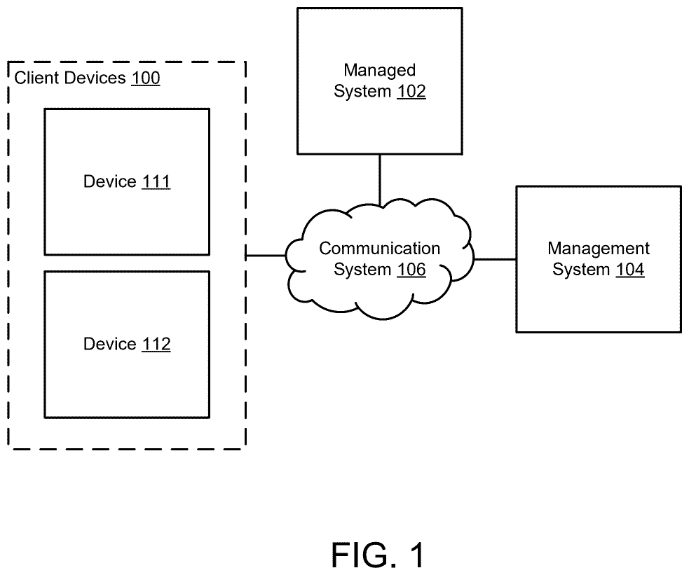

Turning to FIG. 1, a block diagram illustrating a system in accordance with an embodiment is shown. The system shown in FIG. 1 may be a distributed system that provides computer implemented services.

These services may include any type and/or quantity of services. These services may include, for example, database services, data processing services, electronic communication services, and/or any other services that may be provided by one or more computing devices.

Other types of services may be provided by the system shown in FIG. 1 without departing from embodiments disclosed herein.

To provide these services, the system may include any number of data processing systems (e.g., computing devices) such as any of client devices 100. These data processing systems may include any quantity of software components and/or hardware components. These components may include, for example, processors, memory modules, storage devices, communications devices, power components, software applications, device drivers, and/or any other type of component whose respective operation may facilitate various functionalities of the data processing systems. By facilitating such functionalities of the data processing systems, the respective operation of such components may cause the services to be provided.

However, this operation of the hardware components and/or the software components may depend on an architecture of the components used during such operation. For example, the architecture of the components may determine which of the components may contribute to the operation, and how the contributing components may be configured to (i) interact with one another during the operation, and/or (ii) utilize various types and/or quantities of data.

Consequently, if the components are not configured to be in a correct architecture, then the services may not be provided as expected or desired by a consumer of such services (e.g., correct services may not be provided as expected and/or desired by a service providing entity such as management system 104, discussed further below).

To increase a likelihood of providing computer implemented services as expected and/or desired by a consumer of such services (e.g., a client of management system 104 desiring the services), a distributed system may include components such as those illustrated and discussed with regard to FIG. 1, below.

In general, embodiments disclosed herein relate to systems, devices, and methods for managing operation of a system that may provide computer implemented services. To do so, an architectural regulation framework may be leveraged.

This architectural regulation framework may include (i) obtaining an artificial intelligence (AI) model adapted for use in a workflow performed by a managed system, and (ii) deploying the managed system to perform the workflow in which the AI model may be a part. For example, this managed system (e.g., 102) may be managed by a management system (e.g., 104) for the client of the management system.

In doing so, a likelihood of providing the services as expected and/or desired by the client (e.g., the consumer of the services) may be increased. For example, this increased likelihood may be due to performance of system management actions being based on system expectations for the managed system that are determined by the client. These expectations may be identified by obtaining a non-actionable goal description and key performance indicators (KPI) from the client and for the AI model.

Using these expectations, a knowledge base of previously used AI models may be leveraged to obtain metrics for the AI model, thereby enabling, based on the metrics, selection of the AI architecture for the AI model. For example, this knowledge base may include proprietary information of the management system regarding the previously used AI models. Additionally, for example, the AI architecture may define (at least in part) operation of the managed system that depends on using the AI model and that is expected by the client. In turn, the knowledge base may be further leveraged to select a supportive hardware system (e.g., hardware that supports the AI architecture and the KPI) for the managed system. The managed system may then be deployed based on the selected AI architecture and the selected hardware system. The managed system may thereby provide the computer implemented services as expected by the client after deployment.

To provide the above noted functionality, the system of FIG. 1 may include client devices 100, managed system 102, management system 104, and communication system 106. Each of these is discussed below.

Client devices 100 may include any number of data processing systems such as devices 111 and 112. Any of these data processing systems may (i) use any number of the previously used AI models, for example, if previously managed by management system 104, (ii) provide computer implemented services, (iii) communicate with various systems, devices, and/or entities within the system of FIG. 1 (e.g., other devices of client devices 100, managed system 102, management system 104, and/or other devices not explicitly shown in FIG. 1) via, for example, operable connections that facilitate data transmissions, and/or (iv) cooperate with the various systems, devices, and/or entities (e.g., management system 104) to facilitate the previously mentioned architectural regulation framework.

Furthermore, at least a portion of client devices 100 may be associated with the previously mentioned client (e.g., the consumer of the services). Similarly, managed system 102 may also be, for example, associated with the client.

Managed system 102 may (i) be implemented by a data processing system that is managed by management system 104, (ii) provide computer implemented services (e.g., as expected by the client), (iii) communicate with the various systems, devices, and/or entities within the system of FIG. 1, and/or (iv) cooperate with the various systems, devices, and/or entities (e.g., management system 104) to facilitate the previously mentioned architectural regulation framework.

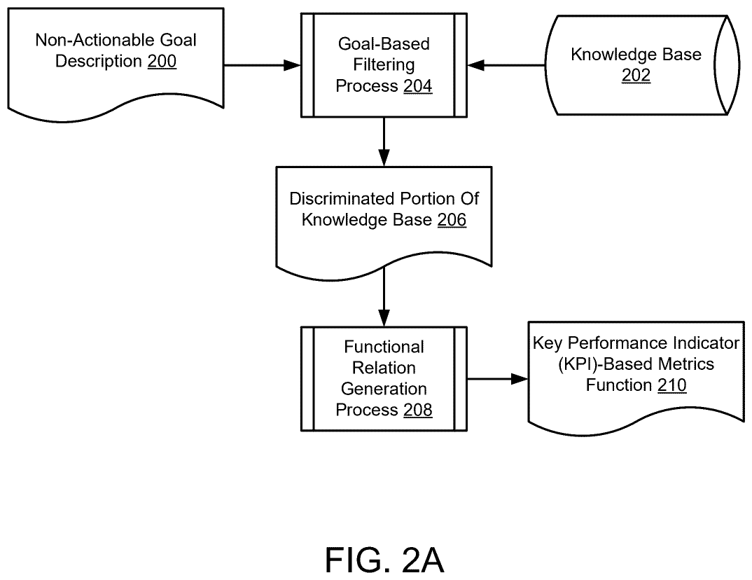

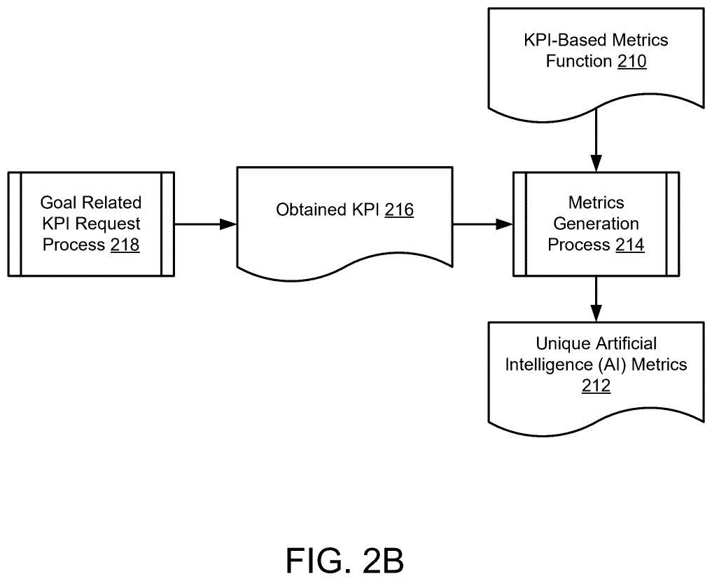

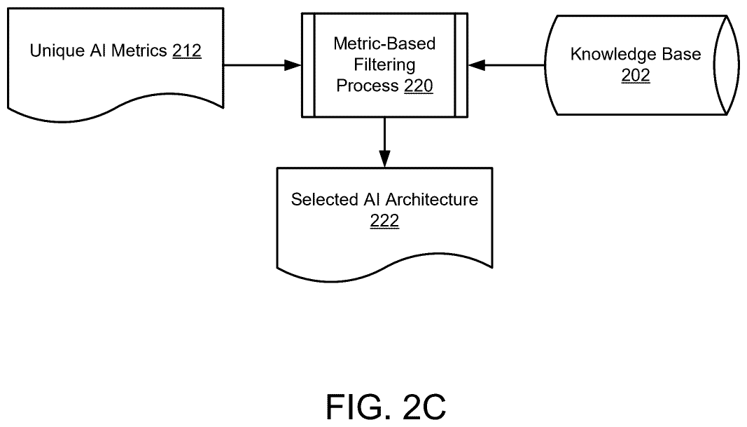

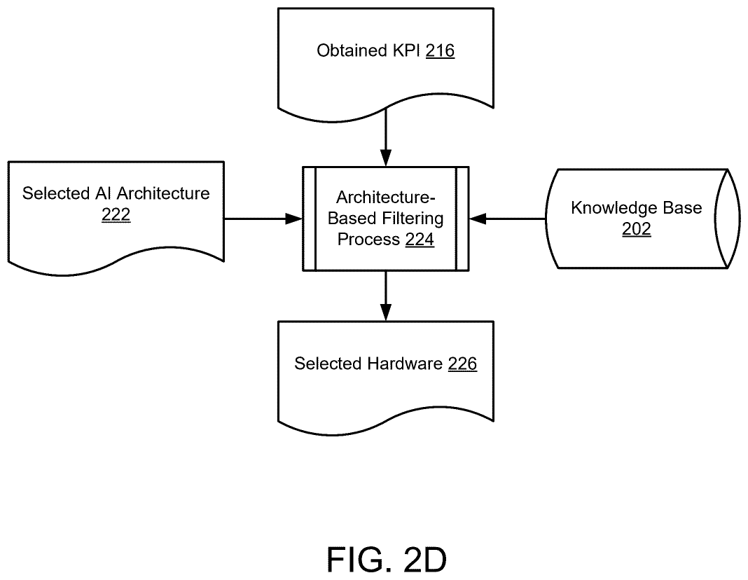

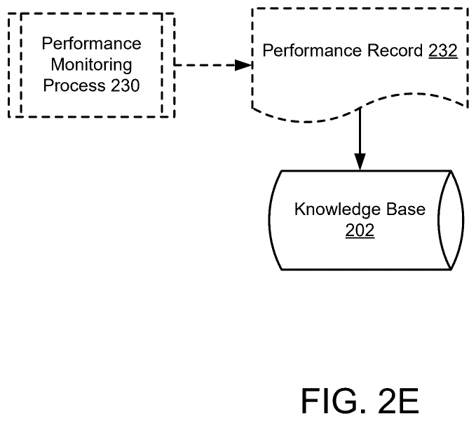

For example, previously mentioned and also discussed further below with regard to FIGS. 2A-2E, the client may provide, at least in part, system expectations for the AI model to be used in a workflow to be performed by managed system 102.

To provide its functionality, managed system 102 may, as previously mentioned, be implemented by a data processing system similar to those of client devices 100. Therefore, managed system 102 may include any number of hardware components and/or software components to facilitate operation of, and therefore, facilitate performance of the workflow by, managed system 102. In doing so, computer implemented services may be provided based on the workflow performed by managed system 102.

For example, the operation of managed system 102 may be facilitated based on a respective AI architecture used by managed system 102 (e.g., via internal networks of interconnections between the components whose use depends on their configurations and configurations of each of the components) during the performance of the workflow. For example, such operation may depend on the types and/or quantities of the components, how such components interact with one another, and/or data each component may be adapted to use, for example, as specified by the respective AI architecture in which these components may be a part.

Therefore, modifying any aspect of such an architecture may also modify the operation, and thus, may result in modifying the services based on the modified operation.

To obtain the AI model for use in the workflow performed by managed system 102, managed system 102 may first be managed by management system 104, as discussed below, to obtain the AI model.

Management system 104 may (i) manage other systems such as managed system 102, (ii) provide computer implemented services, (iii) communicate with the various systems, devices, and/or entities within the system of FIG. 1, and/or (iv) cooperate with the various systems, devices, and/or entities to facilitate the previously mentioned architectural regulation framework.

To provide its functionality, management system 104 may include any number of devices (e.g., data processing systems) collaboratively working to facilitate the architectural regulation framework. As part of the architectural regulation framework, management system 104 may, for example, (i) obtain the system expectations, (ii) obtain metrics based on the system expectations, (iii) select the AI architecture based on the metrics, and (iv) select hardware, based on the system expectations, that supports the AI architecture. Once the AI architecture and the supporting hardware are selected, deployment of the managed system may be initiated to use the AI model during performance of a respective workflow.

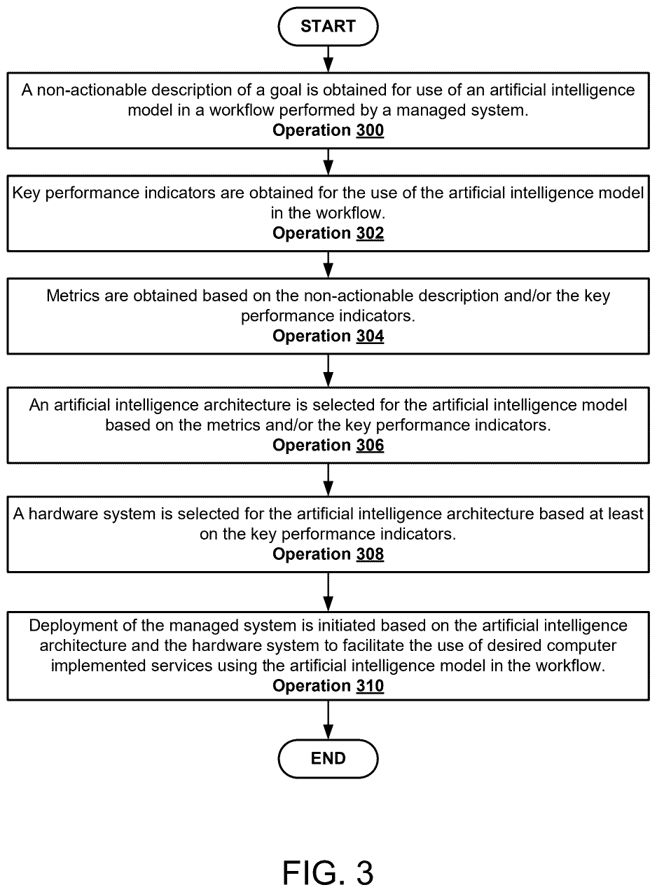

For additional information regarding the architectural regulation framework, refer to FIGS. 2A-3.

When providing their functionality, client devices 100, managed system 102, and/or management system 104 may perform all, or a portion, of the method shown in FIG. 3.

Any devices (and/or components thereof) included in the system of FIG. 1 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system.

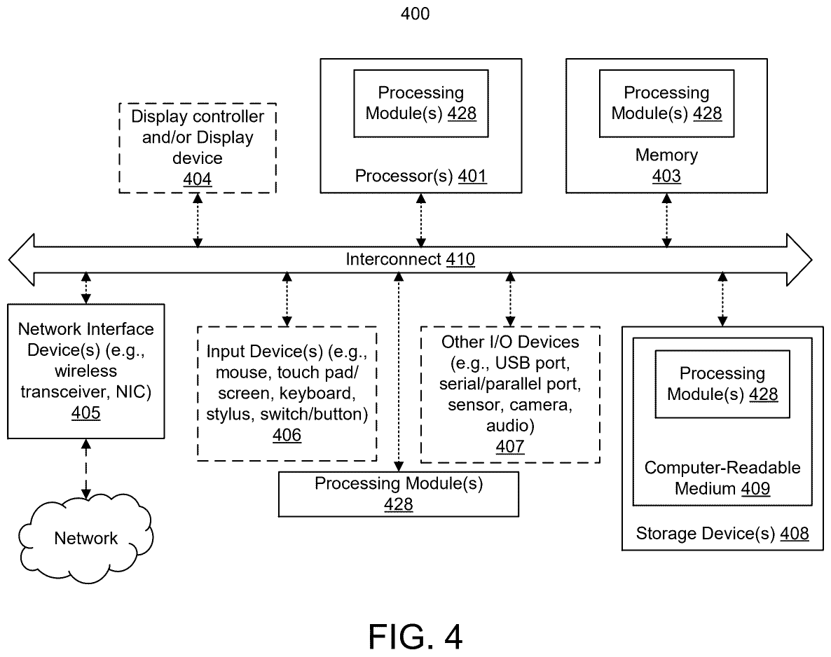

For additional details regarding computing devices, refer to FIG. 4.

Any of the components illustrated in FIG. 1 may be operably connected to each other (and/or components not illustrated) with a communication system (e.g., 106) utilized by client devices 100, managed system 102, and/or management system 104 to, for example, cooperate with one another to facilitate the architectural regulation framework.

In an embodiment, this communication system may include one or more networks that facilitate communication between any number of components. The networks may include wired networks and/or wireless networks (e.g., and/or the Internet). The networks may operate in accordance with any number and types of communication protocols (e.g., such as the internet protocol).

Thus, by facilitating such a framework as the architectural regulation framework, there may be an increased likelihood of providing computer implemented services as expected and/or desired by the client by basing management of the managed system on the system expectations provided by the client.

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2E. These data flow diagrams may illustrate how data may be obtained and used within the system of FIG. 1.

In the data flow diagrams, such as in FIGS. 2A-2E, flows of data and processing of data are illustrated using different sets of shapes. In the context of these data flow diagrams, a first set of shapes (e.g., 200, 206, etc.) is used to represent data structures, a second set of shapes (e.g., 204, 208, etc.) is used to represent processes performed using and/or that generate data, and a third set of shapes (e.g., 202, etc.) is used to represent large scale data structures such as databases (e.g., that include some type of schema and/or a large repository of (e.g., proprietary) data).

Turning to FIG. 2A, a first data flow diagram in accordance with an embodiment is shown. The first data flow diagram may illustrate data used in and data processing performed in identifying a reliable way of obtaining metrics for an AI model (e.g., the AI model that may be used in the workflow performed by managed system 102 as previously discussed).

To do so, for example, (i) a goal-based filtering process (e.g., 204) may be performed, and (ii) a functional relation generation process (e.g., 208) may be performed. For example, during goal-based filtering process 204, both (i) non-actionable goal description 200 and (ii) knowledge base 202 may be ingested. Once ingested, non-actionable goal description 200 and knowledge base 202 may be subjected to any number of data filtering processes. These data filtering processes may be based on, for example, non-actionable goal description 200.

For example, goal-based filtering process 204 may use a type of non-actionable goal description 200 as a key to perform a lookup for any quantity of corresponding data stored in knowledge base 202, knowledge base 202 and non-actionable goal description 200 each being discussed below.

Knowledge base 202 may be implemented by a large data repository, and therefore, may include any type and quantity information regarding any number of previously used AI models (e.g., the proprietary information regarding the previously used AI models managed by management system 104). Each of the AI models may be similar and/or different from one another. For example, knowledge base 202 may include text, pictures, video, etc. regarding performance for each previously used AI model.

To differentiate information regarding the AI models, knowledge base 202 may be organized as, for example, a table including rows, each respective row corresponding to one of the AI models.

For example, each row may include information regarding a corresponding AI model and/or references to other data structures that include information regarding the corresponding AI model. Further, the rows may be keyed to facilitate efficient searches for data regarding properties of the corresponding AI model. These properties may include, for example, (i) a non-actionable goal description associated with the corresponding AI model, (ii) desired (e.g., by an associated client) key performance indicators (KPI) associated with the corresponding AI model, (iii) actual KPI achieved by the corresponding AI model based on performance of workflows using the corresponding AI model, (iv) metrics of the corresponding AI model defining the corresponding AI model's AI architecture, (v) the AI architecture (e.g., configurations and other AI architecture associated data) associated with the corresponding AI model, (vi) a supporting hardware system issued for the corresponding AI architecture, and/or (vii) any other properties of the corresponding AI model, not to be limited by embodiments discussed herein.

It will be appreciated that contents of knowledge base 202 may be leveraged any number of times throughout facilitation of the architectural regulation framework as discussed throughout, but not to be limited by, embodiments herein.

Non-actionable goal description 200 may be based on information obtained directly and/or indirectly from, for example, the client. For example, obtaining non-actionable goal description 200 may include (ii) distributing a first prompt regarding an existing approach used in a workflow and a desired change in the existing approach that is likely to improve a business goal for the workflow; and (ii) obtaining a first response to the first prompt. The first response may therefore include and/or indicate the information regarding non-actionable goal description 200 which may, in turn, be used (and/or already include) the type of non-actionable goal description 200.

Accordingly, the type of non-actionable goal description 200 may include the information regarding the existing approach used in the workflow and the desired change in the existing approach that is likely to improve the business goal for the workflow. For example, non-actionable goal description 200 may be implemented by (e.g., the first response may include) a string of data such as “using an AI model to sell more sticker decals on average by close of business each day than was previously sold on average by close of business each day during the week prior”.

This implementation may include identifying the type of non-actionable goal description 200 to be, for example, (i) a change to using an AI model for a business which did not previously depend on AI models, (ii) an increase in a volume of product sold by a business using the AI model, and/or (iii) any other desired change in the existing approach of the workflow that is likely to improve a business goal for the workflow. Alternatively, in some cases for example, the type may be implemented simply as an industry sector to which the AI model may contribute (e.g., an industry sector associated with sticker decal sales).

Therefore, during goal-based filtering process 204, various actions (e.g., data removal actions) that are based on non-actionable goal description 200 may be performed on knowledge base 202 to obtain discriminated portion of knowledge base 206. For example, discriminated portion of knowledge base 206 may be any number of the previously used AI models from knowledge base 202 that are likely to be relevant to one another based on the type of non-actionable goal description 200.

Discriminated portion of knowledge base 206 may, for example, then be ingested during functional relation generation process 208 to obtain key performance indicator (KPI)-based metrics function 210. For example, functional relation generation process 208 may include interpolation-based processing of data included in discriminated portion of knowledge base 206. The output of functional relation generation process 208 may indicate one or more relationships identified between one or more of the properties of the previously used AI models from the discriminated portion, the one or more relationships being, for example, consistent relative to the type of non-actionable goal description 200. Such relationships may be expressed using, for example, KPI-based metrics function 210.

It will be appreciated that the consistency of the one or more identified relationships may vary by a (e.g., negligible) degree of variance deemed acceptable on a case-by-case basis, requirements for the acceptability being determined by, for example, an authority associated with management system 104.

For example, KPI-based metrics function 210 may be implemented by an identifiable relationship between the actual KPIs of corresponding (and previously used) AI models and the metrics defining respective AI architectures of the corresponding AI models, the identifiable relationship being consistent (e.g., within the negligible degree of variance in the consistency) for each of the any number of AI models included in discriminated portion of knowledge base 206.

Therefore, should new KPI be desired by, for example, the client, metrics for a new AI model associated with non-actionable goal description 200 may be obtained based on the newly desired KPI and KPI-based metrics function 210.

For additional information regarding obtaining metrics based on new KPI (e.g., using KPI-based metrics function 210), refer to FIG. 2B, below.

Turning to FIG. 2B, a second data flow diagram in accordance with an embodiment is shown. The second data flow diagram may illustrate data used in and data processing performed in obtaining metrics for an AI model (e.g., the AI model that may be used in the workflow performed by managed system 102 as previously discussed).

To do so, a metrics generation process (e.g., 214) may be performed. For example, during metrics generation process 214, (i) KPI-based metrics function 210 and (ii) obtained KPI 216 may both be ingested. Once ingested, obtained KPI 216 may be subjected to the previously identified relationship indicated by KPI-based metrics function 210 to obtain unique artificial intelligence (AI) metrics 212. Unique AI metrics 212 may include any number of AI model metrics that may each be associated with a performance rating that may range from low (e.g., less than adequate performance) to high (e.g., exceeding expected and/or desired performance).

These performance ratings may be implemented by, for example, (i) percentages, (ii) performance labels (e.g., “low” for low performance, “moderate” for performance that is near expectation, and “high” for meeting or exceeding expectation), (iii) rankings (e.g., each ranking being based on default/general AI model performance data from commonly used AI, based on the type of non-actionable goal description 200, etc.), and/or (iv) other schema for evaluating metrics, not to be limited by embodiments discussed herein.

Based on obtained KPI 216 and KPI-based metrics function 210, unique AI metrics 212 may include, for example, (i) high accuracy over time, (ii) low model complexity, (iii) moderate response time, (iv) moderate elasticity, (v) high load balancing, (vi) high model stability, (vii) moderate sensitivity, (viii) high resilience, (ix) high coherence, and/or (x) any other metrics used to quantify performance of the AI model.

In this example, a relationship between obtained KPI 216 and unique artificial intelligence (AI) metrics 212 may be the consistent identified relationship discussed previously. For example, obtained KPI 16 may include the new KPI desired by the client, mentioned above with regard to obtaining metrics based on new KPI in FIG. 2A.

Such desired KPI may include, for example, (i) an increasing sales growth, measured based on a week-by-week basis, (ii) an increase in the average purchase power of sticker decal buyers over time, (iii) a steady and/or increasing conversion rate regarding how many sale leads are converting to completed sticker decal sales, and/or (iv) any other quantifiable measurements for success of the AI model, not to be limited by embodiments discussed herein, and the success being relative to the type of non-actionable goal description 200.

To obtain the desired KPI, goal related KPI request process 218 may be performed. For example, goal related KPI request process 218 may include (ii) distributing a second prompt regarding quantifiable measurements for success of the desired change in the existing approach; and (ii) obtaining a second response to the second prompt. The second response may therefore include obtained KPI 216.

For additional information regarding how unique artificial intelligence (AI) metrics 212 may be used, refer to FIG. 2C discussed below.

Turning to FIG. 2C, a third data flow diagram in accordance with an embodiment is shown. The third data flow diagram may illustrate data used in and data processing performed in selecting an AI architecture (e.g., 222) for an AI model (e.g., the AI model that may be used in the workflow performed by managed system 102 as previously discussed).

To do so, a metrics-based filtering process (e.g., 220) may be performed. For example, during metrics-based filtering process 220, (i) unique artificial intelligence (AI) metrics 212 and (ii) knowledge base 202 may both be ingested. Once ingested, data included in knowledge base 202 may be subjected to any number of additional data filtering processes to identify AI architectures that meet or exceed the metrics included in unique artificial intelligence (AI) metrics 212. Such AI architectures may include configurations for hardware and/or software components that determine types and/or a quantity of functionalities provided by the hardware and/or software components, and how they may be provided.

It will be appreciated that any quantity of AI architectures may be identified during metric-based filtering process 220 and that additional selection refining processes may be performed to select, for example, a single AI architecture (E.g., 222). Such additional selection refining processes may include selecting from the any quantity of the identified AI architectures based on, for example, cost placed on the client by particular AI architectures, obtained KPI 216, and/or other factors relevant to, for example the client's ability to utilize the AI model. Thus, selected AI architecture 222 may be obtained based on performance of metrics-based filtering process 220.

For additional information regarding how selected AI architecture 222 may be used, refer to FIG. 2D discussed below.

Turning to FIG. 2D, a fourth data flow diagram in accordance with an embodiment is shown. The fourth data flow diagram may illustrate data used in and data processing performed in selecting supportive hardware (e.g., 226) for an AI model (e.g., the AI model that may be used in the workflow performed by managed system 102 as previously discussed).

To do so, an architecture-based filtering process (e.g., 224) may be performed. For example, during architecture-based filtering process 224, (i) selected AI architecture 222, (ii) obtained KPI 216, and (iii) knowledge base 202 may each be ingested.

Once ingested, data included in knowledge base 202 may be further subjected to any number of additional data filtering processes, similarly discussed above with regard to metric-based filtering process 220 in FIG. 2C, to select hardware for a hardware system capable of supporting selected AI architectures 222 while also meeting or exceeding obtained KPI 216. Thus, selected hardware 226 may be obtained based on performance of architecture-based filtering process 224.

Using selected hardware 226, selected AI architecture 222, obtained KPI 216, non-actionable goal description 200, and/or other information regarding expected performance of the AI model, managed system 102 may be otherwise ready for deployment. Once deployed, managed system 102 may provide the computer implemented services as expected by the client by using the AI model to perform its workflow.

For additional information regarding performance of the workflow and/or additional information regarding knowledge base 202, refer to FIG. 2E discussed below.

Turning to FIG. 2E, a fifth data flow diagram in accordance with an embodiment is shown. The fifth data flow diagram may illustrate data used in and data processing performed in managing data stored in, for example, knowledge base 202.

For example, assume that the managed system performs the workflow using the AI model discussed above after managed system 102's deployment. Such workflow performance may be monitored over time (e.g., starting from the moment of successful deployment of the managed system and/or the providing of the computer implemented services).

To monitor the performance of the workflow, performance monitoring process 230 may be performed. For example, during performance monitoring process 230 a record may be populated with information regarding various properties of the AI model and how these various properties impact the AI model's success relative to, for example, the type of non-actionable goal description 200. Once populated with the information upon completion of performance monitoring process 230, performance record 232 may be obtained.

Based on this monitoring, performance record 232 may therefore include various corresponding properties of the AI model. These corresponding properties may include, for example, (i) the non-actionable goal description for the AI model, (ii) the desired KPI (e.g., obtained KPI 216), (iii) actually met or exceeded KPI, (iv) metrics of the AI model (e.g., unique AI metrics 212), (v) the AI architecture of the AI model (e.g., selected AI architecture 222), (vi) a hardware system supporting the AI model (e.g., selected hardware 226), and/or (vii) any other data regarding properties of the AI model not to be limited by embodiments discussed herein.

Once performance record 232 is obtained, knowledge base 202 may be updated to include performance record 232 (e.g., the data from performance record 232). In doing so, future facilitation of the architectural regulation framework may include accessibility to (and therefore, consideration of) how the AI model performed, the AI model having become one of the previously used AI models from knowledge base 202 upon completion of the update of knowledge base 202.

It will be appreciated that in FIG. 2E, performance monitoring process 230 and performance record 232 are illustrated with dashed borders. These dashed borders are included to discuss how this process (230) and this data structure (232) may each be performed and/or obtained, respectively, any number of times.

For example, instead of data associated with the AI model discussed throughout FIGS. 1-2D, each of the any number of times may regard a different performance of a different AI model used in a workflow performed by a same or different managed system post deployment of the same or different managed system (e.g., all the managed systems being managed by management system 104).

Therefore, each performance record may be populated by data associated with a different AI model's performance, each performance record being subsequently used to update knowledge base 202. Knowledge base 202 may thereby by managed to include up-to-date information regarding the previously used AI models.

In doing so, the architectural regulation framework's leveraging of knowledge base 202 may increase a likelihood of deploying managed systems with an increased likelihood of providing computer implemented services to clients as expected by the clients.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

For additional information and/or examples regarding the architectural regulation framework, refer to FIG. 3 further below.

Thus, as discussed with regard to FIGS. 2A-2E, an architectural regulation framework may be facilitated by any number of devices such as any of client devices 100, managed system 102, and/or management system 104 cooperating with one another as part of, for example, the system shown and discussed with regard to FIG. 1.

While illustrated in FIGS. 2A-2E with a limited number of specific components, a system may include additional, fewer, and/or different components without departing from embodiments disclosed herein.

As discussed above, the components of FIGS. 2A-2E may facilitate and/or perform various functionalities to facilitate the architectural regulation framework. FIG. 3 illustrates a method that may be facilitated and/or performed by the components of FIGS. 1-2E.

In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method for managing operation of a system in accordance with an embodiment is shown. The method may be performed, for example, by a management system (e.g., 104), and/or any other entity.

At operation 300, A non-actionable description of a goal is obtained for use of an artificial intelligence (AI) model in a workflow performed by a managed system. The non-actionable goal description may be obtained by (i) distributing (e.g., by management system 104) a first prompt regarding an existing approach used in the workflow and a desired change in the existing approach that is likely to improve a business goal for the workflow, and (ii) obtaining (e.g., by the management system) a first response to the first prompt. For example, the non-actionable description of the goal may be obtained as discussed with regard to non-actionable goal description 200 in FIG. 2A.

Once obtained, the non-actionable description of the goal may be used to discriminate any number of relevant AI models from a knowledge base of previously used AI models. These discriminated AI models may then, for example, be analyzed to identify a relationship between properties of a previously used AI model, the relationship being similarly identifiable across each of the discriminated AI models. For example, this relationship may be expressed as a function obtained via interpolation of data for the discriminated AI models.

The identified relationship may be between the actually met or exceeded key performance indicators (KPI) of a previously used AI model and metrics of the previously used AI model that may have been used to select an AI architecture for the previously used AI model. This identified relationship between the KPI and metrics may therefore be identifiable for each of the discriminated/previously used AI models. For example, the identified relationship may be obtained and/or used as discussed with regard to KPI-based metrics function 210 in FIGS. 2A-2B.

At operation 302, key performance indicators (KPI) are obtained for the use of the artificial intelligence model in the workflow. The KPI may be obtained by (i) distributing (e.g., by the management system) a second prompt regarding quantifiable measurements for success of the desired change in the existing approach, and (ii) obtaining (e.g., by the management system) a second response to the second prompt. For example, the KPI may be obtained as discussed with regard to obtained KPI 216 in FIG. 2B.

Once obtained, these KPI may be processed and/or otherwise analyzed based on the identified relationship, as discussed below.

At operation 304, metrics are obtained based on the non-actionable goal description and/or the key performance indicators (KPI). The metrics may be obtained by (i) discriminating a portion of a knowledge base of information regarding managed systems managed by the management system, and (ii) inferring, using the portion of the knowledge base, the metrics.

The discrimination of the portion may be performed as discussed with regard to operation 300. For example, based on the discrimination, the relationship between the KPI and metrics may be identified, this identified relationship being, for example, KPI-based metrics functions 210 as discussed with regard to FIG. 2B.

To infer the metrics, the KPI for the AI model may, for example, be populated into KPI-based metrics function 210 to output metrics that reflect the identified relationship when analyzed next to the KPI. These outputted metrics may be unique AI metrics 212, discussed with regard to FIG. 2B. Unique AI metrics 212 may thus include, for example, metrics for the AI model such as accuracy, precision, recall, F1 score, mean absolute error (MAE), mean squared error (MSE), training and inference time, resource utilization, latency, throughput, robustness, and scalability.

It will be appreciated that, as previously discussed, the metrics for the AI model may include quantifications regarding operation of the AI model, and the KPI may include quantifications regarding success in use of the AI architecture in future performances of the workflow. Once obtained, the metrics may be used to select an AI architecture, as discussed below.

At operation 306, an artificial intelligence (AI) architecture is selected for the artificial intelligence model based on the metrics and/or the key performance indicators (KPI). The AI architecture may be selected by identifying AI architectures from the knowledge base that meet or exceed the metrics. For example, once obtained, the metrics (along with the KPI) may be processed and/or otherwise analyzed based on various AI architectures in the knowledge base to identify any number of the AI architectures that meet or exceed, for example, the metrics. For example, to meet or exceed the metrics, an AI architecture may include configurations that may, when properly applied to a managed system, cause the metrics to be met or exceeded by the selected AI architecture.

It will be further appreciated that additional selection processes may be performed to obtain a single AI architecture as discussed with regard to selected AI architecture 222 in FIG. 2C.

Once selected, the single AI architecture may be used to select a hardware system, as discussed below.

At operation 308, a hardware system is selected for the artificial intelligence (AI) architecture based at least on the key performance indicators (KPI). The hardware system may be selected by, for example, similar processes to those discussed with regard to operation 306 and/or with regard to FIG. 2C. Therefore, the hardware system may include hardware components and configurations for the hardware components. These components and corresponding configurations, once identified and selected, being acquired and then positioned with one another and/or operably connected to one another to facilitate individual and/or collaborative processes for the managed system.

It will be appreciated that the occurrence of acquiring such components, followed by operably connecting and/or configuring the components, may occur, for example, at operation 308, as mentioned above, or during, for example, operation 310, discussed below.

It will be further appreciated that, although the hardware system is selected for the artificial intelligence (AI) architecture based at least on the key performance indicators (KPI), any and/or all of (i) the KPI, (ii) the knowledge base, and/or (iii) the selected architecture may be on what the selecting of the hardware system depends,

Upon selection of the hardware system, deployment of the managed system may be initiated based on the selected hardware system, the selected AI architecture, the metrics, the non-actionable discussion of the goal, etc., as discussed below.

At operation 310, deployment of the managed system is initiated based on the artificial intelligence (AI) architecture and the hardware system to facilitate the use of desired computer implemented services using the artificial intelligence (AI) model in the workflow. The deployment may be initiated by, for example, a fabrication of the managed system may be performed and/or performance that may otherwise begin a facilitation of management of the managed system. For example, assume a scenario in which the fabrication is performed. This fabrication may include (i) procurement of the hardware system such that each of the hardware components are positioned and operably connected with one another, in addition to each of the components and their respective operations being configured as determined by selecting either the AI architecture or the hardware system, (ii) additional configuration for the managed system such that the hardware system (now fabricated) is able to correctly use the AI architecture when performing the workflow, (iii) provision of the managed system (implemented by the correctly configured hardware system to use the AI architecture to perform the workflow) for the client may be facilitated, and/or (iv) any other number of processes may be performed to prepare the managed system for providing computer implemented services.

The method may end following operation 310.

Thus, using the method illustrated in FIG. 3, embodiments disclosed herein may manage systems to increase the likelihood of providing the computer implemented services as expected and/or desired by the client.

Any of the processes and/or components illustrated in and/or discussed with regard to FIGS. 1-3 may be implemented with and/or used in conjunction with one or more computing devices.

Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a system, the method comprising:
obtaining, by a management system, a non-actionable description of a goal for use of an artificial intelligence model in a workflow performed by a managed system;
obtaining, by the management system, key performance indicators for the use of the artificial intelligence model in the workflow;
obtaining, by the management system, metrics based on the non-actionable description and/or the key performance indicators;
selecting, by the management system, an artificial intelligence architecture for the artificial intelligence model based on the metrics and/or the key performance indicators;
selecting, by the management system, a hardware system for the artificial intelligence architecture based at least on the key performance indicators; and
initiating, by the management system, deployment of the managed system based on the artificial intelligence architecture and the hardware system to facilitate the use of desired computer implemented services using the artificial intelligence model in the workflow.

2. The method of claim 1, wherein the obtaining of the non-actionable description comprises:
distributing a first prompt regarding an existing approach used in the workflow and a desired change in the existing approach that is likely to improve a business goal for the workflow; and
obtaining a first response to the first prompt.

3. The method of claim 2, wherein the obtaining of the key performance indicators comprises:
distributing a second prompt regarding quantifiable measurements for success of the desired change in the existing approach; and
obtaining a second response to the second prompt.

4. The method of claim 1, wherein the obtaining of the metrics comprises:
discriminating a portion of a knowledge base of information regarding managed systems managed by the management system; and
inferring, using the portion of the knowledge base, the metrics.

5. The method of claim 4, wherein the metrics comprise quantifications regarding operation of artificial intelligence models, and the key performance indicators comprise quantifications regarding success in using the artificial intelligence architecture in future performances of the workflow.

6. The method of claim 1, wherein the artificial intelligence architecture comprises an artificial intelligence model.

7. The method of claim 6, wherein the artificial intelligence architecture further comprises configurations for use of the artificial intelligence architecture.

8. The method of claim 7, wherein the hardware system comprises hardware components.

9. The method of claim 8, wherein the hardware system further comprises configurations for the hardware components.

10. The method of claim 1, wherein the metrics comprise:
accuracy,
precision,
recall,
F1 score,
mean absolute error (MAE),
mean squared error (MSE),
training and inference time,
resource utilization, latency,
throughput,
robustness, and
scalability.

11. A non-transitory machine-readable medium having instructions stored therein, which when executed by a processor, cause the processor to perform operations for managing operation of a system, the operations comprising:
obtaining, by a management system, a non-actionable description of a goal for use of an artificial intelligence model in a workflow performed by a managed system;
obtaining, by the management system, key performance indicators for the use of the artificial intelligence model in the workflow;
obtaining, by the management system, metrics based on the non-actionable description and/or the key performance indicators;
selecting, by the management system, an artificial intelligence architecture for the artificial intelligence model based on the metrics and/or the key performance indicators;
selecting, by the management system, a hardware system for the artificial intelligence architecture based at least on the key performance indicators; and
initiating, by the management system, deployment of the managed system based on the artificial intelligence architecture and the hardware system to facilitate the use of desired computer implemented services using the artificial intelligence model in the workflow.

12. The non-transitory machine-readable medium of claim 11, wherein the obtaining of the non-actionable description comprises:
distributing a first prompt regarding an existing approach used in the workflow and a desired change in the existing approach that is likely to improve a business goal for the workflow; and
obtaining a first response to the first prompt.

13. The non-transitory machine-readable medium of claim 12, wherein the obtaining of the key performance indicators comprises:
distributing a second prompt regarding quantifiable measurements for success of the desired change in the existing approach; and
obtaining a second response to the second prompt.

14. The non-transitory machine-readable medium of claim 11, wherein the obtaining of the metrics comprises:
discriminating a portion of a knowledge base of information regarding managed systems managed by the management system; and
inferring, using the portion of the knowledge base, the metrics.

15. The non-transitory machine-readable medium of claim 14, wherein the metrics comprise quantifications regarding operation of artificial intelligence models, and the key performance indicators comprise quantifications regarding success in using the artificial intelligence architecture in future performances of the workflow.

16. . A data processing system, comprising:
a processor; and
a memory coupled to the processor to store instructions, which when executed by the processor, cause the processor to perform operations for managing operation of a system, the operations comprising:
obtaining, by a management system, a non-actionable description of a goal for use of an artificial intelligence model in a workflow performed by a managed system;
obtaining, by the management system, key performance indicators for the use of the artificial intelligence model in the workflow;
obtaining, by the management system, metrics based on the non-actionable description and/or the key performance indicators;
selecting, by the management system, an artificial intelligence architecture for the artificial intelligence model based on the metrics and/or the key performance indicators;
selecting, by the management system, a hardware system for the artificial intelligence architecture based at least on the key performance indicators; and
initiating, by the management system, deployment of the managed system based on the artificial intelligence architecture and the hardware system to facilitate the use of desired computer implemented services using the artificial intelligence model in the workflow.

17. The data processing system of claim 16, wherein the obtaining of the non-actionable description comprises:
distributing a first prompt regarding an existing approach used in the workflow and a desired change in the existing approach that is likely to improve a business goal for the workflow; and
obtaining a first response to the first prompt.

18. The data processing system of claim 17, wherein the obtaining of the key performance indicators comprises:
distributing a second prompt regarding quantifiable measurements for success of the desired change in the existing approach; and
obtaining a second response to the second prompt.

19. The data processing system of claim 16, wherein the obtaining of the metrics comprises:
discriminating a portion of a knowledge base of information regarding managed systems managed by the management system; and
inferring, using the portion of the knowledge base, the metrics.

20. The data processing system of claim 19, wherein the metrics comprise quantifications regarding operation of artificial intelligence models, and the key performance indicators comprise quantifications regarding success in using the artificial intelligence architecture in future performances of the workflow.
